(19) United States
(12) Patent Application Publication
(10) Pub. No.: US 2017/0190033 A1
(43) Pub. Date: Jul. 6, 2017

(54) Engine Pulley Holder Strap

(71) Applicant: Guillermo Lucas, Saint Augustine, FL (US)

(72) Inventor: Guillermo Lucas, Saint Augustine, FL (US)

(21) Appl. No.: 15/270,429

(22) Filed: Sep. 20, 2016

Related U.S. Application Data
(60) Provisional application No. 62/210,814, filed on Oct. 5, 2015.

(51) Int. Cl. B25B 27/00; B25B 23/00

(52) U.S. Cl. CPC B25B 27/0035; B25B 23/0085

(57) ABSTRACT

A long holding strap, which depending on the counter-clockwise or clockwise lacing of the strap, can assist the user in holding an engine pulley from turning in order to tighten or loosen the hold down nut or bolt, due to the friction exerted on the strap itself.

The strap differs from other similar type products on the market today in that there are no other needed attachments that may interfere with the other engine components, while the engine is still installed in the vehicle where there is limited space and access.

### BACKGROUND OF THE INVENTION

At times during the removal of the crankshaft pulley on an automobile engine, the nut or bolt holding the pulley in place would be so tight that it could not be removed with an impact wrench.

I have tried several of the other tools on the market to hold the pulley from turning, however, they either mar the surface of the pulley when using a “chain whip” or they are very bulky and cumbersome when trying to use them in cramp engine bays.

I came up with a simple solution using a strap that has no other attachments and can be used in the tightest of engine bays. The strap is laced against itself in a clockwise or counter-clockwise direction for tightening and loosening and uses the friction of the strap to hold it in place.

### BRIEF DESCRIPTION OF THE DRAWING

FIG. 1 Shows Strap (10) laced in the clockwise direction around pulley (20) and pulley (30) ready to tighten nut or bolt in pulley.

FIG. 2 Shows Strap (10) in fully extended form.

FIG. 3 Shows lower portion of Strap (10) with ribs.

FIG. 4 Shows lower portion of Strap (10) being flat.

FIG. 5-7 Shows Strap (10) dimensions.

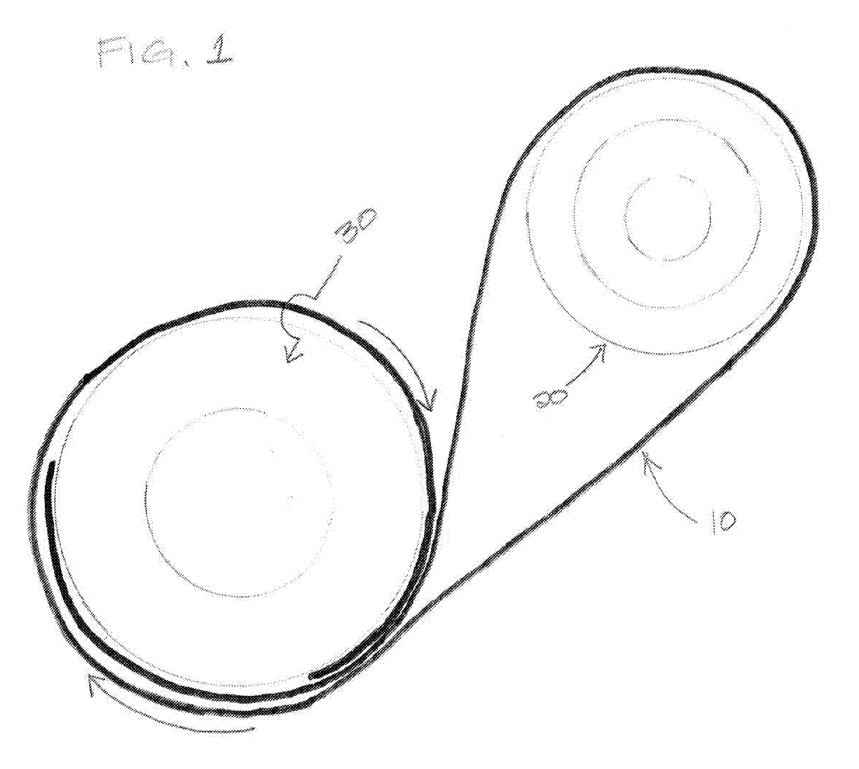

The engine pulley holder strap “Strap Off” is intended to hold an engine pulley from turning in order to remove or tighten the bolt or nut that holds the pulley to the accessory, engine block or the engine's front timing cover.

It is designed to fit into the most cramped of engine compartments on longitudinally or transverse mounted engines. “Strap Off” does not need any other peripheral attachments (which other tools that purport to do the same thing on the market have and which make them more cumbersome to use and sometimes cannot be used due to lack of room in the engine bay) in order to assist the technician in holding the pulley in order to complete the task at hand.

“Strap Off” will hold the pulley in order to remove the nut or bolt and it will hold the pulley in order to tighten the same nut or bolt depending on the “lacing” of “Strap Off”.

“Strap Off” does not mar the surface of the serpentine pulley like most, if not all, “chain whip” pulley holders do. In addition, “Strap Off” does not have any metal structure that holds the strap in order to accomplish the same task which can be hard to mount due to the lack of space in the engine bay.

No more issues trying to hold an engine pulley, no more issues with lack of room and no more worries about damaging the “ribs” on the pulley with “tool's” that are currently on the market to accomplish the same task.

“Strap Off” uses the friction/tension of the strap itself to hold the engine pulley from turning so you can loosen/tighten the nut or bolt.

When “Strap Off” is laced “counter-clockwise” (View 2), it allows the bolt or nut that holds the pulley to be loosened using the tension on the strap.

When “Strap Off” is laced “clockwise” (View 1), it allows the bolt or nut that holds the pulley to be tightened using the tension on the strap.

What is claimed is:

1. A holding device to hold an automobile engine pulley from turning comprising:
A long flexible strap that can be laced counter-clockwise or clockwise to loosen or tighten the nut or bolt holding the pulley.

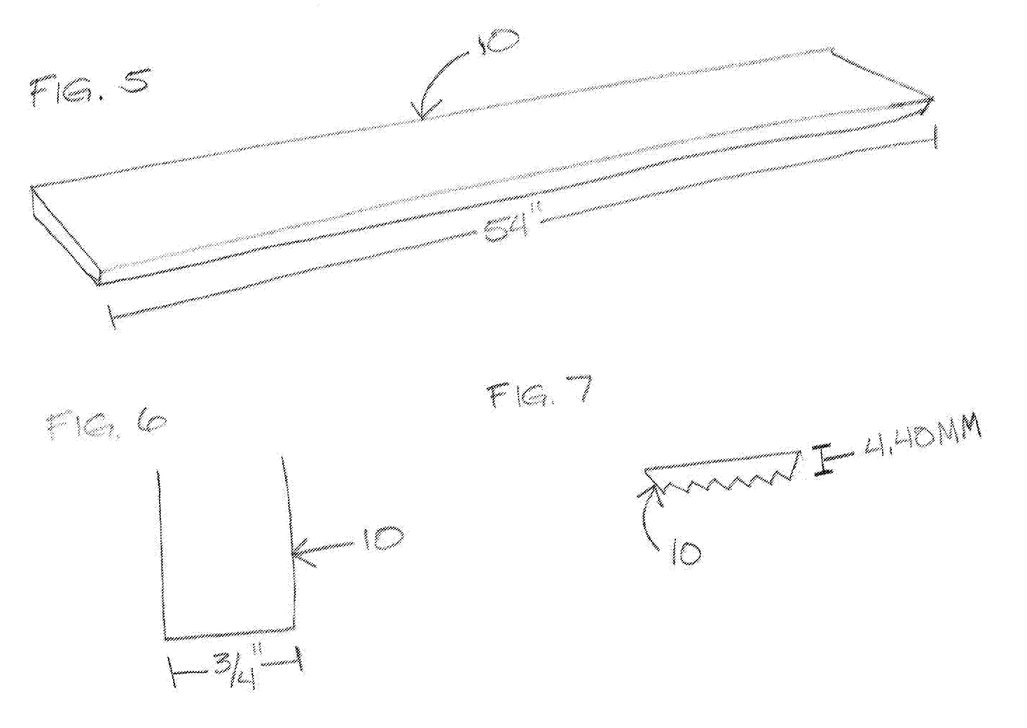

2. The holding device as defined in claim 1, wherein said strap is 54″ long (FIG. 5), ¾″ wide (FIGS. 6) and 4.40 mm thick (FIG. 7).

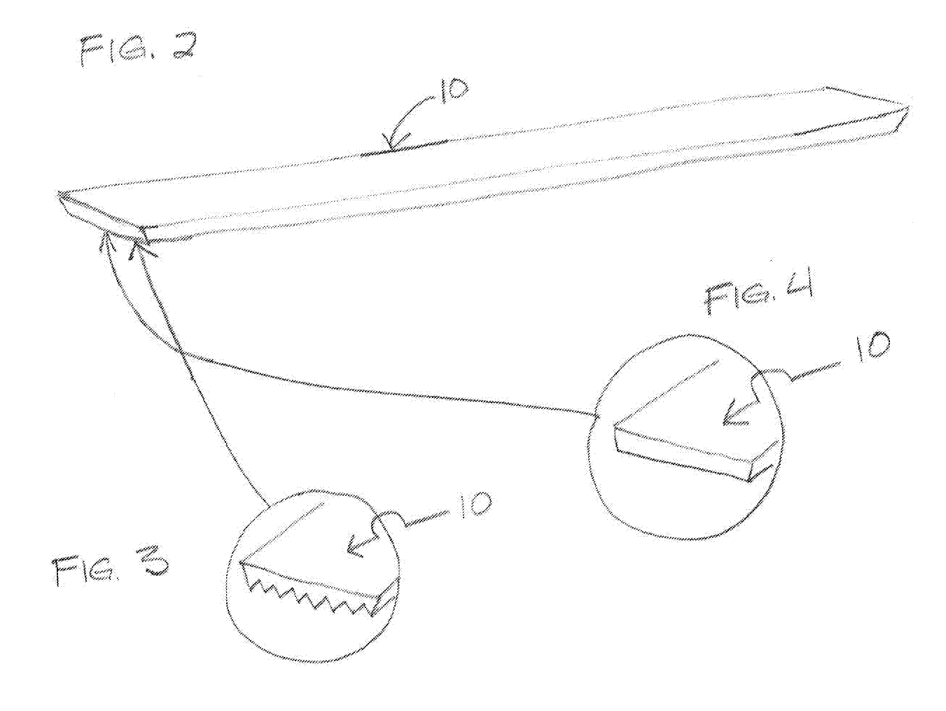

3. The holding device as defined in claim 1, wherein said strap can have a flat lower surface (FIG. 4) or a ribbed lower surface (FIG. 3).
